(19) United States
(12) Patent Application Publication
(10) Pub. No.: US 2026/0319689 A1
(43) Pub. Date: Oct. 15, 2026

(54) MEMORY SYSTEMS, CONTROLLERS, DEVICES, METHODS OF CONTROLLING MEMORY SYSTEMS AND MEDIUMS

(71) Applicant: YANGTZE MEMORY TECHNOLOGIES CO., LTD., Wuhan (CN)

(72) Inventors: Jie JIA, Wuhan (CN); Tao XIONG, Wuhan (CN); Fei HE, Wuhan (CN); Baohuan LIU, Wuhan (CN)

(21) Appl. No.: 19/295,393

(22) Filed: Aug. 8, 2025

(30) Foreign Application Priority Data
Apr. 10, 2025 (CN) 2025104504481

(51) Int. Cl. G06F 3/06

(52) U.S. Cl. CPC G06F 3/0655; G06F 3/0604; G06F 3/0679

(57) ABSTRACT

A memory system comprises: a memory device; and a memory controller having first user data and system metadata buffered therein and configured to: write the system metadata into the memory device in response to occurrence of a power loss event; and write the first user data into the memory device in response to completion of writing the system metadata into the memory device.

### CROSS-REFERENCE TO RELATED APPLICATIONS

The present disclosure claims priority to Chinese Patent Application No. 2025104504481, which was filed on Apr. 10, 2025, and is hereby incorporated herein by reference in its entirety.

### TECHNICAL FIELD

The present application relates to the technical field of memory technology, and in particular, to a memory system, a controller, a device, a method of controlling a memory system and a medium.

### BACKGROUND

In a solid state Drive (SSD), a power loss event refers to a case in which an SSD device suddenly loses external power supply during normal operation.

In the related art, when a power loss event occurs in an SSD device, data loss is reduced through a Power Loss Protection (PLP) process.

However, during the PLP process, SSD devices often fail to start and operate normally (or referred to as “bricking”).

### SUMMARY

The present application provides a memory system, a controller, a device, a method of controlling a memory system and a medium. The technical solution is as follows.

In one aspect, a memory system is provided, comprising:
a memory device; and
a memory controller having first user data and system metadata buffered therein and configured to:
write the system metadata into the memory device in response to occurrence of a power loss event; and
write the first user data into the memory device in response to completion of writing the system metadata into the memory device.

In an example, the memory controller is configured to:
write the first user data into the memory device in response to completion of writing the system metadata into the memory device and completion of processing a first write request submitted to the memory device, and wherein
the first write request is a write request submitted to the memory device before the occurrence of the power loss event, and the first write request indicates to write second user data buffered in the memory controller into the memory device.

In an example, the memory controller is configured to:
send a second write request to the memory device in response to the occurrence of the power loss event, wherein the second write request indicates to write the system metadata into the memory device, and wherein
the memory device is configured to:
process the second write request and the first write request in parallel.

In an example, the memory controller is configured to:
write an updated address mapping relationship into the memory device in response to completion of processing the first write request submitted to the memory device, and wherein
the updated address mapping relationship comprises a mapping relationship between a logical address and a physical address of the second user data.

In an example, the memory controller is configured to:
buffer logical addresses corresponding to user data that has not been written into the memory device in response to the occurrence of the power loss event, wherein the user data that has not been written into the memory device comprises the first user data; and
write the system metadata into the memory device in response to completion of buffering the logical addresses.

In an example, the memory controller is configured to:
send a reset request to the memory device in response to the occurrence of the power loss event, wherein the reset request indicates to terminate a data erase event performed in the memory device.

In an example, the memory controller is configured to:
write address mapping data buffered in a buffer of the memory controller into the memory device in response to the occurrence of the power loss event, wherein the address mapping data comprises an address mapping relationship between a physical address and a logical address; and
write the system metadata into the memory device in response to completion of writing the address mapping data into the memory device.

In an example, the memory controller is configured to:
write verification information corresponding to the first user data into the memory device in response to completion of writing the system metadata into the memory device.

In an example, the memory controller is configured to:
write updating data of the system metadata buffered in a buffer of the memory controller into the memory device in response to completion of writing the first user data into the memory device, and wherein
the updating data indicates updating status of the system metadata in the process of writing the system metadata and the first user data into the memory device.

In an example, the memory system comprises a solid state drive SSD.

In an example, the memory device comprises a single-level cell SLC.

In another aspect, a memory controller is provided, comprising:
a buffer configured to buffer first user data and system metadata; and
one or more processors configured to:
write the system metadata into a memory device in response to occurrence of a power loss event; and
write the first user data into the memory device in response to completion of writing the system metadata into the memory device.

In another aspect, an electronic device is provided, comprising:
the memory system according to any one of the above examples; and
a host coupled to the memory system.

According to another aspect, a method of controlling a memory system is provided, comprising:
writing system metadata buffered in a memory controller into a memory device in response to occurrence of a power loss event; and
writing first user data buffered in the memory controller into the memory device in response to completion of writing the system metadata into the memory device.

In an example, writing the first user data buffered in the memory controller into the memory device in response to completion of writing the system metadata into the memory device comprises:
writing the first user data into the memory device in response to completion of writing the system metadata into the memory device and completion of processing a first write request submitted to the memory device, and wherein
the first write request is a write request submitted to the memory device before the occurrence of the power loss event, and the first write request indicates to write second user data buffered in the memory controller into the memory device.

In an example, writing the system metadata buffered in the memory controller into the memory device in response to the occurrence of the power loss event comprises:
sending a second write request to the memory device in response to the occurrence of the power loss event, wherein the second write request indicates to write the system metadata into the memory device, and wherein
the memory device is configured to process the first write request and the second write request in parallel.

In an example, the method further comprises:
writing an updated address mapping relationship into the memory device in response to completion of writing the system metadata into the memory device and completion of processing the first write request submitted to the memory device, and wherein
the updated address mapping relationship comprises a mapping relationship between a logical address and a physical address of the second user data.

In an example, writing the system metadata buffered in the memory controller into the memory device in response to the occurrence of the power loss event comprises:
buffering logical addresses corresponding to user data that has not been written into the memory device in response to the occurrence of the power loss event, wherein the user data that has not been written into the memory device comprises the first user data; and
writing the system metadata into the memory device in response to completion of buffering the logical addresses.

In an example, the method further comprises:
sending a reset request to the memory device in response to the occurrence of the power loss event, wherein the reset request is to terminate a data erase event performed in the memory device.

In an example, writing the system metadata buffered in the memory controller into the memory device in response to the occurrence of the power loss event comprises:
writing address mapping data buffered in the memory controller into the memory device in response to the occurrence of the power loss event, wherein the address mapping data comprises an address mapping relationship between a physical address and a logical address; and
writing the system metadata into the memory device in response to completion of writing the address mapping data into the memory device.

In an example, the method further comprises:
writing verification information corresponding to the first user data into the memory device in response to completion of writing the system metadata into the memory device.

In an example, the method further comprises:
writing updating data of the system metadata buffered in a buffer of the memory controller into the memory device in response to completion of writing the first user data into the memory device, and wherein
the updating data is to indicate updating status of the system metadata in the process of writing the system metadata and the first user data into the memory device.

In an example, the memory system comprises a solid state drive SSD.

In an example, the memory device comprises a single-level cell SLC.

In another aspect, a computer-readable storage medium is provided, having stored therein at least one computer program, wherein the at least one computer program is loaded and executed by a processor to implement a method of controlling a memory system according to any one of the foregoing examples.

### BRIEF DESCRIPTION OF THE DRAWINGS

In order to more clearly describe the technical solutions in the examples of present application, the following briefly describes the accompanying drawings that need to be used in the description of the examples. Obviously, the accompanying drawings in the following description are merely some examples of present application, other accompanying drawings may be obtained from these drawings without creative labor for those of ordinary skill in the art.

FIG. 1 is a schematic diagram of a computer system provided by an example of present application.

FIG. 2 is a structural schematic diagram of a solid state disk provided by an example of present application.

FIG. 3 is a structural schematic diagram of a memory device provided by an example of present application.

FIG. 4 is a circuit schematic diagram of a memory device provided by an example of present application.

FIG. 5 is a schematic diagram of a memory system provided by an example of present application.

FIG. 6 is a schematic diagram of a memory controller provided by an example of present application.

FIG. 7 is a schematic diagram of a computer system provided by another example of present application.

FIG. 8 is a flowchart of a method of controlling a memory system provided by an example of present application.

FIG. 9 is an interaction flowchart of a method of controlling a memory system provided by an example of present application.

FIG. 10 is an interaction flowchart of a method of controlling a memory system provided by another example of present application.

FIG. 11 is an interaction flowchart of a method of controlling a memory system provided by yet another example of present application.

### DETAILED DESCRIPTION

Examples of present application are further described in detail below with reference to the accompanying drawings.

First, a computer system involved in present application is described.

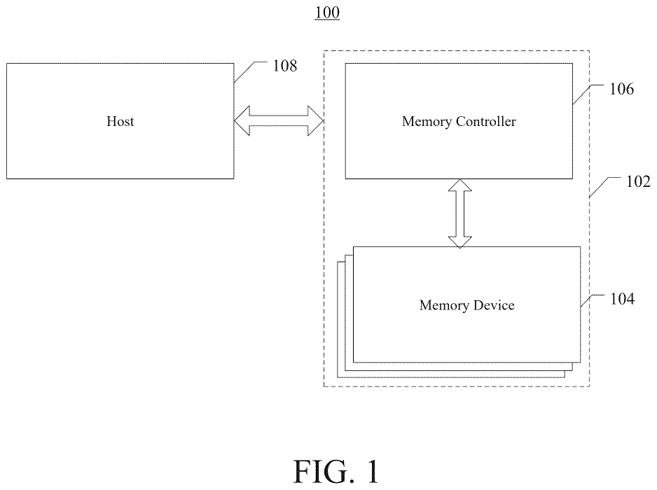

The computer system provided in the example of present application may include a host and a memory system. FIG. 1 is a schematic diagram of a computer system provided by an example of present application. As shown in FIG. 1, the system 100 includes a memory system 102 and a host 108 coupled to the memory system 102. The memory system 102 includes a memory device 104, and a memory controller 106 coupled to the memory device 104 and configured to control the memory device 104.

In an example, system 100 may be integrated into various types of electronic devices. The electronic device may include a mobile phone, a desktop computer, a laptop computer, a tablet computer, a vehicle computer, a game console, a printer, a positioning device, a wearable electronic device, an intelligent sensor, a Virtual Reality (VR) device, an Augmented Reality (AR) device, or the like.

The memory system 102 may be implemented as a type of memory system such as Universal Flash Storage (UFS) or a Solid State Disk (SSD). In this example of present application, taking the memory system being implemented as an SSD as an example for illustration.

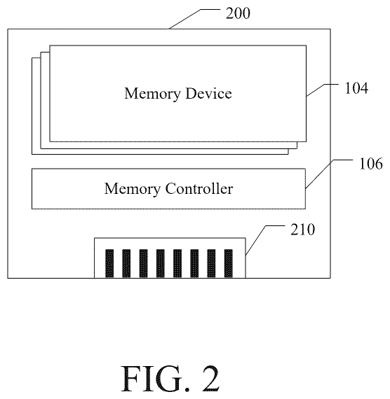

As another example, FIG. 2 is a structural schematic diagram of a solid state disk according to present application. As shown in FIG. 2, a solid state drive (SSD) 200 includes a memory device 104 and a memory controller 106. The solid state drive 200 may also include a connector 210 that couples the solid state drive 200 with a host.

In an example, the memory device 104 may be implemented as a Not-AND flash, such as a 3-Dimension (3D) NAND flash. The structure of the memory device 104 will be explained below.

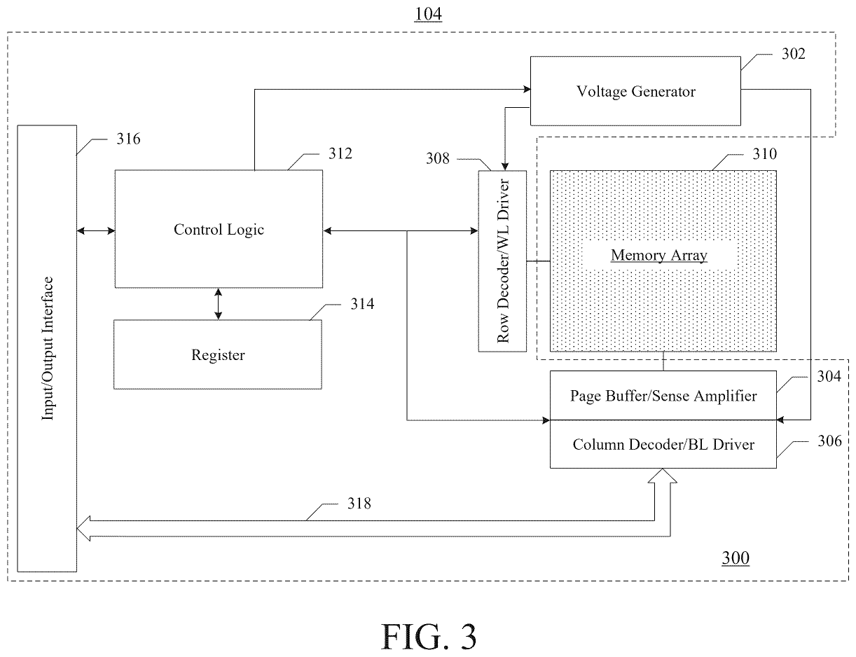

FIG. 3 is a structural schematic diagram of a memory device provided by an example of present application. As shown in FIG. 3, the memory device 104 includes a peripheral circuit 300 and a memory array 310.

The peripheral circuit 300 is configured to write data into and read data from the memory array 310. The peripheral circuit 300 includes a voltage generator 302, a page buffer/sense amplifier 304, a column decoder/bit line (BL) driver 306, a row decoder/word line (WL) driver 308, a control logic 312, a register 314, an input/output interface 316, and a data bus 318. In some examples, additional peripheral circuits not shown in FIG. 3 may also be included.

The voltage generator 302 may be configured to be controlled by the control logic 312, and generate word line voltages (e.g., read voltage, program voltage, pass voltage, local voltages, verify voltage, etc.), bit line voltages, and source line voltages to be supplied to the memory array 310.

The page buffer/sense amplifier 304 may be configured to read data from and program (write) data into the memory array 310 according to control signals from the control logic 312. In one example, the page buffer/sense amplifier 304 may store one page of program data (write data) to be programmed into one page of the memory array 310. In another example, the page buffer/sense amplifier 304 may perform a program verify operation to ensure that data has been correctly programmed into memory cells coupled to a selected word line. In yet another example, the page buffer/sense amplifier 304 may also sense low power signals from bit lines representing data bits stored in memory cells and amplify small voltage swings to identifiable logic levels in a read operation.

The column decoder/bit line driver 306 may be configured to be controlled by control logic 312 and select one or more memory strings (e.g., NAND memory strings) by applying a bit line voltage generated from voltage generator 302.

The row decoder/word line driver 308 may be configured to be controlled by the control logic 312 and select/deselect a block of the memory array 310 and select/deselect a word line of the block. The row decoder/word line driver 308 may also be configured to drive a word line using a word line voltage (VWL) generated from the voltage generator 302. In some examples, the row decoder/word line driver 308 may also select/deselect and drive source select gate line and drain select gate line. Illustratively, the row decoder/word line driver 308 is configured to perform an erase operation on memory cells coupled to the selected word line(s).

The control logic 312 may be coupled to other components of each peripheral circuit described above and configured to control operations of the other components of each peripheral circuit.

The register 314 may be coupled to the control logic 312, and include a status register, a command register, and an address register for storing status information, command opcodes (OP codes), and command address for controlling operation of each peripheral circuit.

The input/output interface 316 may be coupled to control logic 312 and act as a control buffer to buffer and relay a control command received from a host (not shown) to control logic 312 and to buffer and relay status information received from control logic 312 to the host. The input/output interface 316 may also be coupled to the column decoder/bit line driver 306 via data bus 318 and act as a data input/output interface and data buffer to buffer and relay data to or from memory array 310.

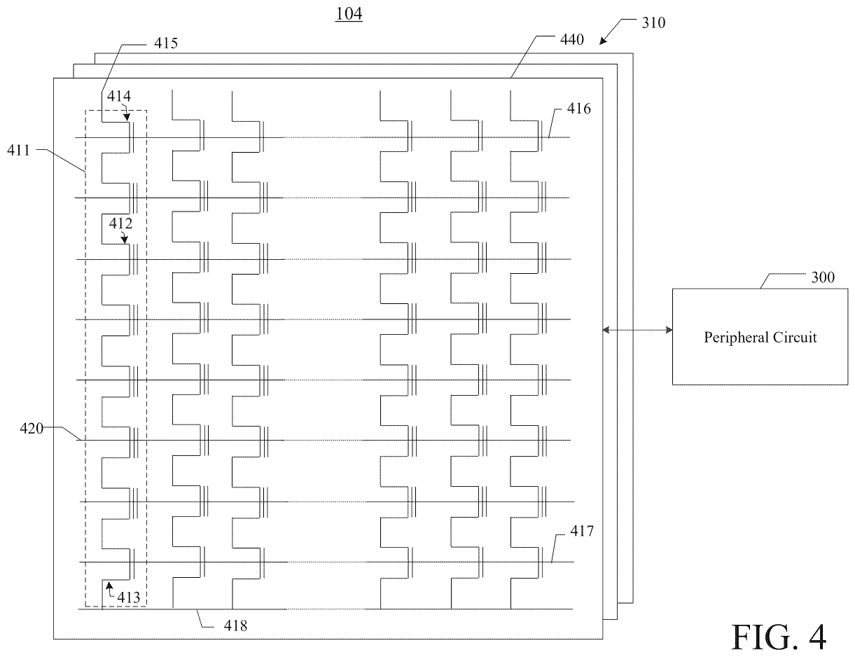

FIG. 4 is a circuit schematic diagram of a memory device provided by an example of present application. As shown in FIG. 4, the memory device 104 includes:
a memory array 310 including a plurality of memory cell rows;
a plurality of word lines 420 coupled to the plurality of memory cell rows respectively; and
a peripheral circuit 300 coupled to the plurality of word lines 420 and configured to perform operations such as programming (e.g., writing) or reading on selected ones of the plurality of rows of memory cells coupled to the selected word line, where operations such as programming or reading are performed.

The memory array 310 may be a flash memory array (e.g., a NAND memory array). The memory array 310 includes a plurality of memory strings 411 arranged in an array, each memory string 411 extending vertically above a substrate (not shown). In some examples, each memory string 411 includes a plurality of memory cells 412 coupled in series and stacked vertically. The memory cell 412 includes, but is not limited to, a Single-Level Cell (SLC), a Multi-Level Cell (MLC), a Triple-Level Cell (TLC), a Quad-Level Cell (QLC), and the like.

As shown in FIG. 4, each memory string 411 may further include a Source Select Gate (SSG) 413 at the bottom and a Drain Select Gate (DSG) 414 at the top. The source select gate is also referred to as a lower select transistor, a Bottom Select Gate (BSG) or a source select transistor, and the drain select gate is also referred to as an upper select transistor, a Top Select Gate (TSG) or a drain select transistor. The source select gate 413 and the drain select gate 414 may be configured to activate a selected memory string 411 during read and program operations.

In some examples, the drain select gate 414 of each memory string 411 is coupled to a respective bit line 415 from which data may be read or written via an output bus (not shown).

In some examples, each memory string 411 is configured to apply a select voltage (e.g., above a threshold voltage of a transistor having a drain select gate 414) or a deselect voltage (e.g., OV) to a respective drain select gate 414 through one or more DSG lines 416. In some examples, each memory string 411 is configured to be selected or deselected by applying a select voltage (e.g., above a threshold voltage of a transistor having a source select gate 413) or a deselect voltage (e.g., OV) to the respective source select gate 413 through one or more SSG lines 417.

As shown in FIG. 4, the memory strings 411 may be organized into a plurality of blocks 440, and for any one of the plurality of blocks 440, the block 440 may have one source line (SL) 418, where sources of all the memory strings 411 in the block 440 are coupled through the source line 418, and the source line is also referred to as a common source line or an array common source (ACS).

The source line 418 may be used for grounding, to enable subsequent grounding of sources of each memory cell of the memory string in the block 440 in some operations. In some examples, in some other operations, the source of each memory cell of the memory string in the block 440 may be connected to a high voltage through the source line 418.

Each block 440 is a basic data unit for an erase operation, for example, all memory cells 412 on the same block 440 are erased simultaneously. To erase memory cells 412 in a selected block, a source line coupled to the selected block may be biased with an erase voltage (Vers), such as a high positive voltage (20 V or higher).

It should be appreciated that in other examples, the erase operation may be performed at half block level, at quarter block level, or any suitable number of blocks or at any suitable fractional level of a block.

As shown in FIG. 4, the same layer of memory cells 412 of adjacent memory strings 411 in the same block 440 may be coupled by a word line 420 which is used to select which layer of memory cells 412 in the block 440 is affected by read and program operations.

In some examples, each word line 420 is coupled to a page to which a memory cell 412 belongs, where the page is a basic data unit for a program operation. The size of a page may be related to the number of memory strings 411 coupled by the word line 420 in a block 440. Each word line 420 may be coupled on a control gate (e.g., gate electrode) of each memory cell 412 in a respective page. It can be understood that one row of memory cells is a plurality of memory cells 412 located in a same page.

It should be noted that memory cells of a same layer in one block 440 correspond to a same word line, but memory cells of a same layer may be divided into one or more pages. For example, one word line may be coupled to one or more pages.

The peripheral circuit 300 may be coupled to the memory array 310 through bit line 415, word line 420, source line 418, SSG line 417, and DSG line 416. Peripheral circuit 300 may include any suitable analog, digital, and mixed-signal circuit for facilitating operation of memory array 310 by applying at least one of voltage signal and current signal to and sensing at least one of voltage signal and current signal from memory cells 412 via bit line 415, word line 420, source line 418, SSG line 417, and DSG line 416.

For technical details not disclosed in the foregoing related hardware examples of the computer system, please refer to descriptions of the memory system example, the memory controller example, and the method example of present application for understanding.

Secondly, a memory system involved in present application is described, and a method of controlling a memory system involved in the example of present application is performed by the memory system.

In a memory system, such as in a solid state drive SSD, a power loss event refers to a case in which an SSD device suddenly loses external power supply during normal operation. In the related art, when a power loss event occurs in an SSD device, data loss is reduced through a Power Loss Protection (PLP) process. However, during the PLP process, SSD devices often fail to start and operate normally (or referred to as “bricking”).

Based on this, the present application provides a memory system, which could reduce occurrences where failure to successfully write system metadata prevents normal recovery of the memory system, thereby lowering the bricking risk of the memory system and minimizing impacts on user services.

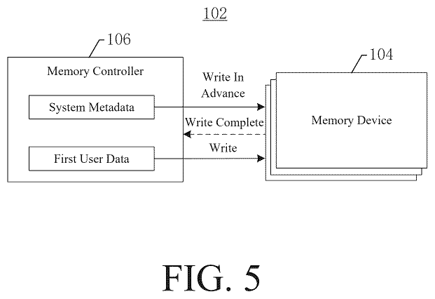

FIG. 5 is a schematic diagram of a memory system 102 provided by an example of present application. As shown in FIG. 5, the memory system 102 includes a memory device 104 and a memory controller 106. In some examples, the memory system 102 includes a solid state drive SSD. In some examples, the memory device 104 includes single-level cells SLC.

The memory controller 106 has first user data and system metadata buffered therein. For example, the memory controller 106 includes a buffer that buffers the first user data and the system metadata.

The user data refers to data that the user actively stores in the memory system 102, such as documents, pictures, videos, application program files, etc., and includes information that the user can directly access and use.

The first user data includes user data that is temporarily stored in the memory controller 106 and to be written into the memory device 104. For example, when a user initiates a write request, the user data will first enter the buffer of the memory controller 106, and then be gradually written into the memory device 104 by the memory controller 106, where the first user data refers to user data that is temporarily stored in the buffer of the memory controller 106 and has not been written into the memory device 104.

System metadata includes auxiliary data generated and maintained by the memory system 102 (such as an SSD) during operation, in other words, the system metadata includes auxiliary data generated by the memory system 102 for managing its operation. The system metadata is used to record management information, operating states, and key parameters of the memory system 102, to ensure that the memory system 102 continues to operate normally when the memory system 102 is powered on next time. For example, after the occurrence of the power loss event in memory system 102, system metadata can ensure that memory system 102 continues to operate normally after power supply is restored.

For example, the system metadata includes at least one of the followings:

### (1) Address Mapping Management Information

The address mapping management information includes an updated location of an address mapping table, where the address mapping table is used to record Logical to Physical (L2P) mapping information of user data.

For example, when the L2P mapping information of the user data changes, Journal and Snapshot will be generated, and the updated location of the journal and the snapshot will be recorded (as system metadata) at this time, so that related journal and snapshot can be quickly found when required by the memory system 102.

### (2) Memory Management Information

The memory management information includes a Bad Block Table, Super Block Information, and the like, where the bad block table is to mark unavailable or damaged physical blocks in the memory device (for example, a NAND flash memory), and the super block information is to record status (for example, erase/write cycles and remaining lifespan) of a super block (a logical unit formed by a plurality of physical blocks).

### (3) Event Log Update Locations

During operation of the memory system 102, various event logs will be generated, and update locations for the event logs need to be recorded (as system metadata), so that related event logs can be quickly found when required by the memory system 102.

It should be noted that the foregoing examples of the system metadata is merely an illustrative description, and the specific data type of the system metadata is not limited in present application. For example, system metadata can also include Error Correction Code (ECC) verification information, power management status, firmware version, etc.

In some examples, the memory controller 106 includes a buffer buffering the first user data and the system metadata.

The memory controller 106 is configured to: write the system metadata into the memory device 104 in response to occurrence of a power loss event; and write the first user data into the memory device 104 in response to completion of writing the system metadata into the memory device 104.

The power loss event refers to an event that the memory system 102 cannot operate normally due to power supply interruption. In the memory system 102, the method of detecting the power loss event includes at least one of the followings: (1) the memory controller 106 monitors the power supply voltage in real time, and determines that the power loss event occurs when it is detected that the power supply voltage drops or falls below a threshold; and (2) when receiving an interrupt signal, the memory controller 106 determines that a power loss event occurs, where the interrupt signal may be sent by a power management chip within the memory system 102, or may be sent by another external device connected to the memory system 102.

After the occurrence of the power loss event, the memory system 102 enters the PLP process. For example, a backup capacitor is equipped in the memory system 102, where the backup capacitor may provide power support for the memory system 102 for a period of time. When the power loss event occurs in the memory system 102, the PLP process is implemented by using the backup capacitor. Taking an SSD as an example, the backup capacitor may be welded on a Printed Circuit Board (PCB) of the SSD, and after the power loss event occurs in the SSD, the backup capacitor provides power for the SSD, so that the SSD enters the PLP process.

In present application, the PLP process performed in the memory system 102 includes: writing the system metadata into the memory device 104; and writing the first user data into the memory device 104 in response to completion of writing the system metadata into the memory device 104. Since that the system metadata is written into the memory device 104 in advance, occurrences where failure to successfully write system metadata prevents normal recovery of the memory system is reduced. It should be emphasized that the method provided in present application is especially applicable to a PLP abnormal scenario, where the PLP abnormal scenario includes but is not limited to: backup capacitor capacity is less than a preset value (for example, insufficient capacitor capacity), performance of the backup capacitor is attenuated, and extreme temperatures (for example, the performance of the backup capacitor decreases due to high temperatures).

In the PLP abnormal scenario, using the method provided in present application ensures that when the backup capacitor can only provide 2-3 seconds of power support during a power loss event, the system metadata is first written into the memory device 104 within this limited power window. Any remaining power is then used to write the first user data into the memory device 104. This approach maximizes the probability of ensuring system metadata integrity, thereby enabling the memory system 102 to maintain normal operation of the memory system 102 through complete system metadata after power restoration, significantly reducing the “bricking” risk of system. In some examples, the system metadata refers to system metadata stored in the cache of the memory device 104 when a power loss event occurs, and may be referred to as first system metadata. The first system metadata is immediately written into the memory device 104 after the power loss event occurs, where the first system metadata includes system metadata that is first written into the memory device 104 after the power loss event occurs.

In some examples, the memory controller 106 is configured to: send a second write request to the memory device in response to the occurrence of the power loss event, where the second write request indicates to write the system metadata into the memory device 104. For example, the second write request indicates to write the system metadata into SLCs of the memory device 104. When a power loss event occurs in the memory system 102, the memory controller 106 first obtains the system metadata currently buffered in the buffer (the buffer in the memory controller 106), encapsulates the system metadata into the second write request, and sends the second write request to the memory device 104. After receiving the second write request, the memory device 104 performs a write procedure for the system metadata included in the second write request.

In some examples, the memory controller 106 is configured to: buffer logical addresses corresponding to user data that has not been written into the memory device 104 in response to the occurrence of the power loss event, where the user data that has not been written into the memory device 104 includes the first user data.

The logical addresses include addresses used by a user or a file system to access user data, and are different from actual physical addresses within the memory device 104. In present application, when a power loss event occurs in the memory system 102, the memory controller 106 records logical addresses of user data that has not been written into the memory device 104. In some examples, the memory controller 106 includes an address buffer unit that may be implemented as a CU (Cache Unit). The address buffer unit is configured to buffer logical addresses of user data, for example, when a power loss event occurs in the memory system 102, the memory controller 106 buffers logical addresses of the user data that has not been written into the memory device 104 to the address buffer unit.

In the foregoing solution, when a power loss event occurs, the memory controller 106 buffers logical addresses corresponding to user data that has not been written into the memory device 104, to facilitate subsequent data recovery. In the recovery process of the memory system, the memory controller 106 directly determines, based on buffered logical addresses, which data needs to be written into the memory device 104 from the cache, thereby simplifying the data recovery process and improving recovery efficiency.

In some examples, the system metadata is written into the memory device 104 in response to completion of buffering the logical addresses. For example, when a power loss event occurs in the memory system 102, the memory controller 106 first buffers logical addresses of user data that has not been written into the memory device 104, and after buffering is completed, the memory controller 106 writes system metadata into the memory device 104. In some examples, the logical addresses may be used as a part of the system metadata, for example, after buffering of the logical addresses is completed, the logical addresses buffered by the memory controller 106 and other system metadata are written into the memory device 104 together.

Alternatively, logical addresses corresponding to user data that has not been written into the memory device 104 is buffered, and system metadata is written into the memory device 104 in response to occurrence of a power loss event. In an example, after the occurrence of the power loss event, the memory controller 106 buffers the logical addresses of user data that has not been written into the memory device 104, and at the same time, the memory controller 106 writes the system metadata into the memory device 104.

In some examples, the user data that has not been written into the memory device 104 further includes second user data.

The second user data refers to user data that is requested to be written in a write request (for example, the first write request described below) that was submitted to the memory device 104 but has not been written completely before the power loss event occurs. For example, when a user initiates a write request, the user data will first enter the buffer of the memory controller 106, and then be gradually written into the memory device 104 by the memory controller 106, where the second user data refers to user data that has entered the write process of the memory device 104 but has not been written completely. For example, in an SSD, the second user data refers to user data that has started being written into a flash memory (for example, a NAND flash memory) but has not completed the erase, program, or verify operations.

In some examples, the memory controller 106 is configured to write address mapping data buffered in a buffer of the memory controller 106 into the memory device 104 in response to the occurrence of the power loss event, where the address mapping data includes an address mapping relationship between a physical address and a logical address. For example, the address mapping data includes an address mapping relationship between a physical address and a logical address of user data already stored in the memory device. In some examples, the address mapping data buffered in the buffer of the memory controller 106 is written into SLC or TLC in the memory device 104 in response to the occurrence of the power loss event.

The memory device 104 can restore the correct access path of the data through the written address mapping relationship, thereby improving the success rate of data recovery and enhancing the fault tolerant capability of the memory system 102.

A physical address refers to an actual storage location in the memory device 104. For example, an address mapping table is stored in the buffer of the memory controller 106, where the address mapping table is to record an address mapping relationship between the physical address and the logical address. In the present application, when a power loss event occurs in the memory system 102, the memory controller 106 writes the address mapping table into the memory device 104.

In some examples, the system metadata is written into the memory device 104 in response to completion of writing the address mapping data into the memory device 104. For example, when a power loss event occurs in the memory system 102, the memory controller 106 first writes the address mapping data into the memory device 104, and after completion of writing the address mapping data into the memory device 104, the system metadata is written into the memory device 104.

Alternatively, in response to the occurrence of the power loss event, the address mapping data buffered in the buffer of the memory controller 106 is written into the memory device 104, and the system metadata is written into the memory device 104. In an example, after the occurrence of the power loss event, the memory controller 106 writes the address mapping data into the memory device 104, and at the same time, the memory controller 106 writes the system metadata into the memory device 104.

In some examples, logical addresses corresponding to user data that has not been written into the memory device 104 is buffered in response to occurrence of a power loss event; address mapping data buffered in the buffer of the memory controller 106 is written into the memory device 104 in response to the buffering of the logical addresses is completed; and the system metadata is written into the memory device 104 in response to completion of writing the address mapping data into the memory device 104. For example, after the occurrence of the power loss event, the memory controller 106 first buffers logical addresses of user data has not been written into the memory device 104, and after the buffering is completed, the memory controller 106 writes an address mapping table into the memory device 104, and after completion of writing the address mapping table into the memory device 104, writes system metadata into the memory device 104.

For example, logical addresses (which may be referred to as target logical addresses) corresponding to user data that has not been written into the memory device 104 is recorded in the address mapping table buffered by the memory controller 106, and physical addresses corresponding to the target logical addresses are marked as UNC in the address mapping table, where the UNC is to indicate that the physical addresses corresponding to the logical addresses are in an undetermined state. The address mapping table is then written into the memory device 104 as address mapping data, so that the memory system 102 can accurately determine user data that needs to be written into the memory device 104.

In some other examples, in response to occurrence of a power loss event, logical addresses corresponding to user data that has not been written into the memory device 104 is buffered, the address mapping data buffered in the buffer of the memory controller 106 is written into the memory device 104, and the system metadata is written into the memory device 104. For example, after the occurrence of the power loss event, the memory controller 106 buffers logical addresses of user data that has not been written into the memory device 104, and meanwhile, the memory controller 106 writes the address mapping table and the system metadata into the memory device 104.

In some examples, the memory controller 106 is configured to send a reset request to the memory device 104 in response to the occurrence of the power loss event, where the reset request indicates to terminate a data erase event performed in the memory device 104. For example, when a power loss event occurs in the memory system 102, the memory controller 106 sends a reset signal to the memory device 104, and after receiving the reset signal, the memory device 104 terminates the data erase operation performed currently. After the data erase operation is terminated, the memory device 104 can immediately proceed with data write operations, thereby ensuring that new data (such as the system metadata and first user data) can be stored in time.

In some examples, the memory controller 106 may send a reset request to the memory device 104 at any time after the power loss event occurs. For example, when a power loss event occurs in the memory system 102, the memory controller 106 immediately sends the reset request to the memory device 104. Alternatively, when a power loss event occurs in the memory system 102, after completion of writing the system metadata and the second user data into the memory device 104, the memory controller 106 immediately sends the reset request to the memory device 104.

In some examples, the memory controller 106 is configured to: write verification information corresponding to the first user data into the memory device 104 in response to completion of writing the system metadata into the memory device 104.

For example, after the system metadata and the second user data has been written into the memory device 104, the verification information corresponding to the first user data is written into the SLC in the memory device 104. Alternatively, after completion of writing the system metadata, the second user data, and the first user data into the memory device 104, the verification information corresponding to the first user data is written into the SLC in the memory device 104.

By writing the verification information corresponding to the first user data into the memory device 104, a direct basis is provided for subsequent data integrity verification. During the data reading or recovery process, whether the data is complete and accurate can be accurately determined by comparing the verification information with the actually read data. This effectively avoids inconsistencies caused by data corruption or loss, thereby improving data reliability and trustworthiness.

In some examples, in response to completion of writing the system metadata into the memory device 104, the verification information corresponding to the first user data is written into the SLC in the memory device 104. In some examples, the verification information may include RAID check code, where the RAID check code is generated by exclusive OR (XOR) operations. For example, the first user data includes at least two data blocks, and the verification information refers to an XOR result between the at least two data blocks. For example, verification information=user data A XOR user data B, or verification information=user data A XOR user data B XOR user data C, where “XOR” represents the XOR operator. Data recovery or repair operations can be performed by using the RAID check code and the remaining data, loss caused by data loss is reduced, minimizing losses due to data loss and enhancing system fault tolerance and recovery capabilities.

In some examples, the memory controller 106 is configured to: write updating data of the system metadata buffered in the buffer of the memory controller into the memory device 104 in response to completion of writing the first user data into the memory device 104. The updating data indicates updating status of the system metadata in the process of writing the system metadata and the first user data into the memory device 104.

In some examples, the updating data of the system metadata buffered in the buffer of the memory controller 106 is written into the SLC of the memory device 104 in response to completion of writing the first user data into the memory device 104.

For example, after the memory controller 106 successfully writes the first user data into the memory device 104, the memory controller 106 writes the updating data of the system metadata buffered in the buffer into the memory device 104. The updating data records the updating status of the system metadata in the entire process of writing the system metadata and the first user data into the memory device 104.

By writing the updating data of the system metadata into the memory device 104, it is ensured that the system metadata stored in the memory device 104 can reflect the latest system status, thereby improving the accuracy of the system metadata, facilitating subsequent data recovery, and avoiding problems such as data read/write errors caused by untimely update of the system metadata.

In some examples, the first user data includes at least two pieces of sub-data. In response to completion of writing the (i+1)-th sub-data into the memory device 104, the (i+1)-th updating data buffered in the buffer of the memory controller 106 is written into the memory device 104. The (i+1)-th updating data indicates updating status of the system metadata in the process of writing the i-th sub-data into the memory device 104, where i is a positive integer.

For example, taking the at least two pieces of sub-data including first sub-data and second sub-data as an example for description. The first sub-data is written into the memory device 104, and in response to completion of writing the first sub-data into the memory device 104, first updating data of the system metadata buffered in the buffer of the memory controller 106 is written into the memory device 104, where the first updating data indicates updating status of the system metadata in the process of writing the system metadata and the first sub-data into the memory device 104. In response to completion of writing the first updating data into the memory device 104, the second sub-data is written into the memory device 104, and in response to completion of writing the second sub-data into the memory device 104, the second updating data of the system metadata buffered in the buffer of the memory controller 106 is written into the memory device 104, where the second updating data indicates updating status of the system metadata in the process of writing the second sub-data into the memory device 104.

In the foregoing solutions, in the process of writing the first user data into the memory device 104, the updating data of the system metadata is written into the memory device 104 in stages, This ensures the timeliness of the system metadata, further guaranteeing that the system metadata stored in the memory system 104 reflects the latest system status.

In some examples, if there are uncompleted write requests submitted to the memory device 104 before the occurrence of the power loss event:

The memory controller 106 is further configured to: write the first user data into the memory device 104 in response to completion of writing the system metadata into the memory device 104 and completion of processing a first write request submitted to the memory device 104. The first write request is a write request submitted to the memory device 104 before the occurrence of the power loss event and indicates to write second user data buffered in the memory controller 106 into the memory device 104.

In some examples, the first user data is written to the SLC of the memory device 104 in response to completion of writing the system metadata into the memory device 104 and completion of processing a first write request submitted to the memory device 104.

After the power loss event occurs in memory system 102, if there is a first write request in the memory system 102, the memory device 104 is configured to: process the second write request and the first write request in parallel; or suspend processing of the first write request, and resume processing of the first write request in response to completion of processing of the second write request.

(1) In the case that the memory device 104 processes the second write request and the first write request in parallel, after the power loss event occurs, the memory controller 106 immediately sends the second write request to the memory device 104, and the memory device 104 performs a write procedure for the system metadata based on the second write request, and meanwhile, the memory device 104 continuously performs a write procedure for the second user data.

In this case, the memory device 104 is allowed to process the request before the power loss event (second user data) and the write request for the system metadata triggered by the power loss event (second write request), simultaneously. The parallel processing capability of the memory device 104 shortens the overall write time, completes more key operations within a limited backup capacitor window, and improves data storage efficiency.

(2) In the case that the memory device 104 suspends processing of the first write request, and resumes processing of the first write request in response to completion of processing of the second write request: after a power loss event occurs, a write procedure for the second user data by the memory device 104 is suspended, and the memory controller 106 immediately sends the second write request to the memory device 104, and the memory device 104 executes the write procedure for the system metadata based on the second write request. After completion of writing the system metadata into the memory device 104, the memory device 104 continues the write procedure for the second user data.

In this case, the memory device 104 is allowed to process the write request for the system metadata (second write request) first, to ensure storage integrity of the system metadata.

In some examples, when the capacity of the backup capacitor is less than a preset capacity, processing of the first write request is suspended, and processing of the first write request is resumed in response to completion of processing of the second write request. When the capacity of the backup capacitor is greater than or equal to the preset capacity, the second write request and the first write request are processed in parallel.

It should be noted that, in present application, the second write request is normally completed before the first write request, for example, the memory system 102 first completes writing the system metadata into the memory device 104 before completing writing the second user data into the memory device 104. This is because the physical write amount of the system metadata is far less than that of the user data (for example, the user data is measured in unit of MB/GB and the system metadata is in KB scale), enabling faster completion of system metadata writes.

In some examples, the memory controller 106 is configured to write the updated address mapping relationship into the memory device 104 in response to completion of processing of the first write request submitted to the memory device 104.

The updated address mapping relationship includes a mapping relationship between a logical address and a physical address of the second user data. For example, an address mapping table is stored in the buffer of the memory controller 106, where the address mapping table is to record an address mapping relationship between a physical address and a logical address. In the present application, when a power loss event occurs in the memory system 102, the memory controller 106 has a logical address of the second user data buffered therein, and when processing of the first write request submitted to the memory device 104 is completed, for example, the second user data has been written into the memory device 104, an actual physical address and the logical address of the second user data may be used for new address mapping relationships to update the address mapping table (for example, a mapping relationship between the physical address and the logical address of the second user data is recorded in the address mapping table). The updated address mapping table is then written into the memory device 104, or the mapping relationship between the physical address and the logical address of the second user data is directly written into the memory device 104.

In some examples, if the address mapping table records the logical address of the second user data and the corresponding physical address is marked with UNC, the UNC identifier is directly updated to the actual physical address of the second user data. The updated address mapping table is then written into the memory device 104.

In some examples, the updated address mapping relationship further includes a mapping relationship between a logical address and a physical address of the system metadata.

For example, when the processing of the second write request submitted to the memory device 104 is completed, for example, the system metadata has been written into the memory device 104, an actual physical address and the logical address of the system metadata may be used for new address mapping relationships to update the address mapping table (for example, a mapping relationship between the physical address and the logical address of the system metadata is recorded in the address mapping table). The updated address mapping table is then written into the memory device 104, or the mapping relationship between the physical address and the logical address of the system metadata is directly written into the memory device 104.

In the foregoing solution, an updated address mapping relationship (a mapping table between a logical address and a physical address) is written immediately after completion of writing data, to avoid data addressing errors caused by outdated address mapping.

In some examples, the memory controller 106 is configured to: write the updating data of the system metadata buffered in the buffer of the memory controller 106 into the memory device 104 in response to completion of writing the first user data into the memory device 104, where the updating data indicates updating status of the system metadata in the process of writing the system metadata and the first user data into the memory device 104.

For example, after the first user data is successfully written into the memory device 104, the memory controller 106 writes the updating data of the system metadata buffered in the buffer into the memory device 104. The updating data records the updating status of the system metadata in the entire process of writing the system metadata and the first user data into the memory device 104.

In conclusion, in the memory system 102 provided in present application, when a power loss event occurs, the system metadata buffered in the memory controller 106 is first written into the memory device 104 to ensure integrity of the system metadata, and then first user data buffered in the memory controller 106 is written into the memory device 104 after completion of writing of the system metadata. Since that the system metadata is written into the memory device 104 in advance, occurrences where failure to successfully write system metadata into the memory device 104 prevents normal recovery of the memory system 102 is reduced, thereby lowering the bricking risk of the memory system 102 and minimizing impacts on user services.

Next, the memory controller in present application is described, and a method of controlling a memory system in the example of present application is performed by the memory controller.

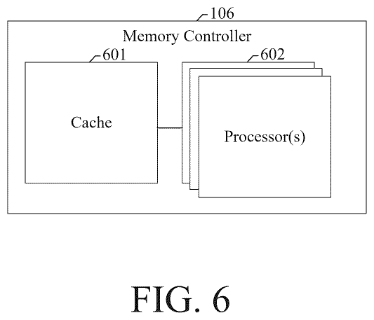

FIG. 6 is a schematic diagram of a memory controller 106 provided by an example of present application. As shown in FIG. 6, the memory controller 106 includes a buffer 601 and one or more processors 602.

The buffer 601 is configured to buffer the first user data and the system metadata. In some examples, the buffer 601 includes a Buffer and a Cache in the memory controller 106, where both the Buffer and the Cache may be implemented as a Dynamic Random Access Memory (DRAM). For example, the first user data is buffered in the buffer, and the system metadata is buffered in the cache, or both the first user data and the system metadata are buffered in the buffer, which is not limited herein.

The one or more processors 602 are configured to: write system metadata into the memory device 104 in response to the occurrence of the power loss event; and write first user data into the memory device 104 in response to completion of writing the system metadata into the memory device 104.

In some examples, the one or more processors 602 are configured to: write the first user data into the memory device 104 in response to completion of writing the system metadata into the memory device 104 and completion of processing a first write request submitted to the memory device 104, and where the first write request is a write request submitted to the memory device 104 before the occurrence of the power loss event, and the first write request indicates to write second user data buffered in the memory controller 106 into the memory device 104.

In some examples, the one or more processors 602 are configured to: send a second write request to the memory device 104 in response to the occurrence of the power loss event, where the second write request indicates to write the system metadata into the memory device 104.

In some examples, the one or more processors 602 are configured to: write an updated address mapping relationship into the memory device 104 in response to completion of processing the first write request submitted to the memory device 104, and where the updated address mapping relationship includes a mapping relationship between a logical address and a physical address of the second user data.

In some examples, the one or more processors 602 are configured to: buffer logical addresses corresponding to user data that has not been written into the memory device 104 in response to the occurrence of the power loss event, where the user data that has not been written into the memory device 104 includes the first user data; and write the system metadata into the memory device 104 in response to completion of buffering the logical addresses. In some examples, the user data that has not been written into the memory device 104 further includes second user data.

In some examples, the one or more processors 602 are configured to: send a reset request to the memory device 104 in response to the occurrence of the power loss event, where the reset request indicates to terminate a data erase event performed in the memory device 104.

In some examples, the one or more processors 602 are configured to: write address mapping data buffered in a buffer 601 of the memory controller 106 into the memory device in response to the occurrence of the power loss event, where the address mapping data includes an address mapping relationship between a physical address and a logical address; and write the system metadata into the memory device 104 in response to completion of writing the address mapping data into the memory device 104.

In some examples, the one or more processors 602 are configured to: write verification information corresponding to the first user data into the memory device 104 in response to completion of writing the system metadata into the memory device 104.

In some examples, the one or more processors 602 are configured to: write updating data of the system metadata buffered in a buffer 601 of the memory controller 106 into the memory device 104 in response to completion of writing the first user data into the memory device 104, and where the updating data indicates updating status of the system metadata in the process of writing the system metadata and the first user data into the memory device 104.

The following describes an example in which the memory system provided in present application is implemented as a solid state drive SSD.

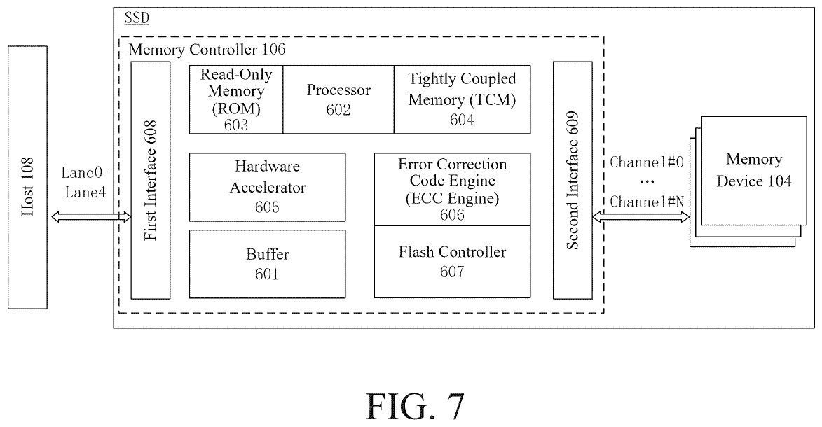

FIG. 7 is a schematic diagram of a computer system provided by an example of present application. As shown in FIG. 7, the computer system includes a solid state drive SSD and a host 108.

The solid state drive SSD includes a memory device 104 and a memory controller 106. For example, the memory controller 106 may be implemented as a System on Chip (SOC) chip in the SSD, or the memory controller 106 is integrated on an SOC chip in the SSD.

The memory device 104 is a part of the SSD for storing data, and consists of flash memory (such as NAND flash memory). The memory device 104 is responsible for storing user data and system metadata.

The memory controller 106 is a core control unit in the SSD, and is responsible for managing read and write operations of data, address mapping, error detection and correction. The various components of the memory controller 106 are as follows:

A buffer 601 is configured to temporarily store data to increase data read and write speeds. In a write operation, user data is first written into buffer 601 and then gradually written into memory device 104. This may reduce frequent access to the memory device 104 and improve overall performance.

One or more processors 602 are configured to execute core control logic of the SSD, such as the PLP process in present application.

A read-only memory (ROM) 603 is configured to store firmware and boot code that runs when the SSD is powered on to initialize the memory controller 106 and boot the memory system 102.

A tightly coupled memory (TCM) 604 is a high-speed memory configured to store frequently accessed data and code. The tightly coupled memory may provide low-latency access, improving performance of the processor.

A hardware accelerator 605 is configured to accelerate specific operations, such as data encryption, decryption, and compression.

An error correction code engine (ECC Engine) 606 is configured to detect and correct errors in data transmission. The error correction code engine 606 adds redundant information to raw data, and identifies and corrects possible bit errors using the additional information at the receiving end, thereby significantly improving data integrity and reliability.

A flash controller 607 is responsible for directly managing operations of flash memory (such as NAND flash memory), including read and write operations, block management, wear leveling, garbage collection, and the like. The flash controller 607 ensures efficient and reliable operations of the flash memory.

A first interface 608 is configured to connect the host 108 and the memory controller 106, to ensure that the host 108 can perform efficient data exchange with the SSD. As shown in FIG. 7, “lane0-lane4” between the first interface 608 and the host 108 represent physical connection channels between the memory controller 106 and the host 108.

A second interface 609 is configured to connect the memory device 104 and the memory controller 106, to enable data transmission between the memory device 104 and the memory controller 106. As shown in FIG. 7, “Channel #0-Channel #N” between the second interface 609 and the memory device 104 represent independent data channels for data exchange between the memory controller 106 and the memory device 104.

In present application, the tightly coupled memory (TCM) 604 or a high-speed cache (not shown in FIG. 7) in the memory controller 106 runs target code that implements the PLP process for the SSD, e.g., the control method of the memory system provided herein. This target code is stored in the memory device 104.

In present application, a Power Loss Protection (PLP) process refers to the processing flow when the SSD experiences a power loss event. The stages of this PLP process, their definitions, as well as the corresponding processing durations and energy consumption (e.g., consumption of backup capacitor capacity), can be referenced in Table 1.

TABLE 1

| | | Duration | | Energy | |
|---|---|---|---|---|---|
| Stages | Definition for stages | (ms) | | consumption (mJ) | |
| Wait Enter PLP | Waiting to enter PLP processing flow | 1.11 | | 17.4 | |
| Flush All The CU Meta | Recording the logical addresses of data | n | | m | |
| | for which write commands are | | | | |
| | submitted to flash memory (e.g., | | | | |
| | NAND flash memory) but not | | | | |
| | completed and data still in the buffer | | | | |
| | and has not been flushed | | | | |
| Journal Map Table Save | Flushing address mapping table | 0.43 | | 5.44 | |
| System Meta Save | Flushing address mapping table | 0.43 | | 5.4 | |
| Wait On Fly TLC Prog | Waiting for write commands submitted | 2.44 | | 39.1 | |
| Done | to flash memory to complete | | | | |
| Reset To Abort Erase | Sending a reset command to terminate | 0.15 | | 1.91 | |
| | an erase command in the flash memory | | | | |
| Update L2P | Completing address mapping data | 1.55 | | 15.17 | |
| | (L2P) update | | | | |
| Flush Buffer Data To SLC | Flushing data still in the buffer to SLC | 1.04 | | 13.77 | |
| RAID Encode Buffer Data | RAID check code when flushing data | 0.89 | | 8.93 | |
| | still in the buffer to SLC | | | | |
| Journal + System Meta | System metadata updating caused by | 0.43 + | 0.43 | 5.44 + | 5.4 |
| Save | user data flushing, a second flushing | | | | |
| Total | | 8.9 + | n | 135.69 + | m |

Flushing refers to writing data in the memory controller 106 of the SSD into the memory device 104.

The LBA that records unflushed data (e.g., the logical addresses of data for which write commands are submitted to flash memory but not completed and data still in the buffer and has not been flushed) has a data volume significantly smaller than an entire SLC stripe during system metadata flushing. This means that system metadata flushing typically occupies the storage space of an entire SLC stripe, while the data volume recorded by the LBA of unflushed data is far smaller than the size of this SLC stripe. If n=0.43 ms and m=5.4 mJ, the total duration in Table 1 above is 9.33 ms, and the energy consumption is 141.09 mJ. If there exists a preservation of LBA records for unflushed data, the physical addresses in the corresponding address mapping data (L2P) for these recorded LBAs should be updated to an “uncompleted or undetermined state” to ensure proper handling of these data when the memory system resumes power supply.

For the detection process of the PLP process in present application, a capacitance value (for example, energy consumption) required by the PLP process may be calculated by reading a health status, and the capacitance value is reduced by disconnecting the capacitor (applicable only to solutions using multiple capacitors). After the capacitance value is reduced, a PLP process is triggered to detect whether the SSD is bricking in a PLP abnormal scenario.

For example, a minimum capacitance value required by a current PLP process is calculated by reading a health state parameter (for example, lifespan of a NAND flash memory, temperature, and the like) of the SSD. Taking the SSD health condition shown in Table 1 as an example, by using the method of controlling the memory system provided in present application, the capacitance required for completing the flushing of the system metadata is 17.4 mJ+5.4 mJ+5.44 mJ+5.4 mJ=33.64 mJ. Under the same condition, if the PLP process that first flushes the user data and then flushes the system metadata is adopted, the capacitance required for flushing the system metadata is 124.85 mJ.

The total capacitance value is reduced by disconnecting some capacitors. Force a power loss and trigger the PLP process, then detect whether the SSD becomes bricked under different capacitance value conditions. When the total capacitance value is reduced below 124.85 mJ, for example, 120 mJ, if the PLP process that first flushes the user data and then flushes the system metadata is adopted, the SSD may become bricked, and if the method of controlling the memory system provided in present application is used, the SSD bricking will not happen.

In conclusion, the SSD provided in this application immediately flushes the system metadata after stopping current system tasks during the PLP processing flow, then handles write commands submitted to the flash memory and flushes user data in the buffer. Under abnormal PLP scenarios (e.g., insufficient backup capacitors), this prevents system bricking caused by unsuccessful system metadata flushing, thereby reducing the risk of SSD bricking in abnormal PLP scenarios. This approach shortens data recovery time for users and minimizes impact on user operations.

Next, a specific procedure for a method of controlling a memory system in present application is described.

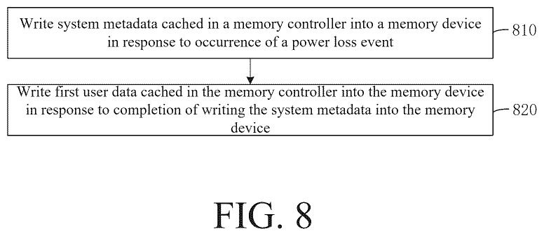

FIG. 8 is a flowchart of a method of controlling a memory system provided by an example of present application, where the memory system 102 provided in present application includes a memory device 104 and a memory controller 106. In some examples, memory system 102 includes a solid state drive SSD. In some examples, the memory device 104 includes single-level cells SLC.

The method of controlling the memory system is performed by the memory controller 106. The method includes the following operation 810 and operation 820.

At 810, write system metadata buffered in a memory controller 106 into a memory device 104 in response to occurrence of a power loss event.

In some examples, the memory controller 106 includes a buffer 601 buffering the system metadata.

In some examples, send a second write request to the memory device 104 in response to the occurrence of the power loss event, where the second write request indicates to write the system metadata into the memory device 104, and where the memory device 104 is configured to: process the first write request and the second write request in parallel.

In some examples, buffer logical addresses corresponding to user data that has not been written into the memory device 104 in response to the occurrence of the power loss event, where the user data that has not been written into the memory device 104 includes the first user data; and write the system metadata into the memory device 104 in response to completion of buffering the logical addresses.

In some examples, send a reset request to the memory device 104 in response to the occurrence of the power loss event, where the reset request indicates to terminate a data erase event performed in the memory device 104.

In some examples, write address mapping data buffered in the memory controller 106 into the memory device 104 in response to the occurrence of the power loss event, where the address mapping data includes an address mapping relationship between a physical address and a logical address; and write the system metadata into the memory device 104 in response to completion of writing the address mapping data into the memory device 104.

At 820, write first user data buffered in the memory controller 106 into the memory device 104 in response to completion of writing the system metadata into the memory device 104.

In some examples, the memory controller 106 includes a buffer 601 buffering the first user data.

In some examples, write the first user data into the memory device 104 in response to completion of writing the system metadata into the memory device 104 and completion of processing a first write request submitted to the memory device 104, and where the first write request is a write request submitted to the memory device 104 before the occurrence of the power loss event, and the first write request indicates to write second user data buffered in the memory controller 106 into the memory device 104.

In some examples, write an updated address mapping relationship into the memory device 104 in response to completion of writing the system metadata into the memory device 104 and completion of processing the first write request submitted to the memory device 104, and where the updated address mapping relationship includes a mapping relationship between a logical address and a physical address of the second user data.

In some examples, write verification information corresponding to the first user data into the memory device 104 in response to completion of writing the system metadata into the memory device 104.

In some examples, write updating data of the system metadata buffered in a buffer 601 of the memory controller 106 into the memory device 104 in response to completion of writing the first user data into the memory device 104, and where the updating data is to indicate updating status of the system metadata in the process of writing the system metadata and the first user data into the memory device 104.

To sum up, according to the method of controlling the memory system provided in this example of present application, when a power loss event occurs, the system metadata buffered in the memory controller 106 is first written into the memory device 104 to ensure integrity of the system metadata, and then first user data buffered in the memory controller 106 is written into the memory device 104 after completion of writing of the system metadata. Since that the system metadata is written into the memory device 104 in advance, occurrences where failure to successfully write system metadata into the memory device 104 prevents normal recovery of the memory system 102 is reduced, thereby lowering the bricking risk of the memory system 102 and minimizing impacts on user services.

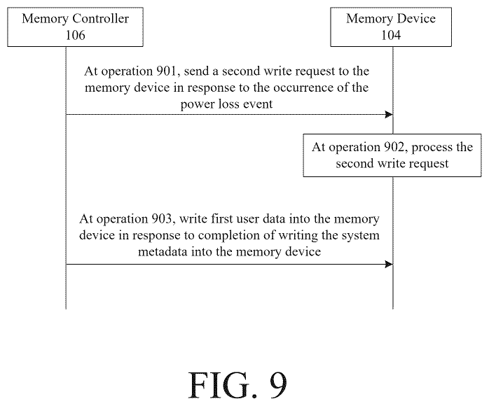

FIG. 9 is an interaction flowchart of a method of controlling a memory system provided by an example of present application. As shown in FIG. 9, the flow includes the following operation 901 to operation 903.

At 901: The memory controller 106 sends a second write request to the memory device 104 in response to the occurrence of the power loss event.

The second write request indicates to write system metadata into the memory device 104.

In some examples, the memory controller 106 is configured to: write address mapping data buffered in the memory controller 106 into the memory device 104 in response to the occurrence of the power loss event, where the address mapping data includes an address mapping relationship between a physical address and a logical address; and write the system metadata into the memory device 104 in response to completion of writing the address mapping data into the memory device 104.

In some examples, the memory controller 106 is configured to: buffer logical addresses corresponding to user data that has not been written into the memory device 104 in response to the occurrence of the power loss event, where the user data that has not been written into the memory device 104 includes the first user data; and write the system metadata into the memory device 104 in response to completion of buffering the logical addresses.

In some examples, the memory controller 106 is configured to: send a reset request to the memory device 104 in response to the occurrence of the power loss event, where the reset request indicates to terminate a data erase event performed in the memory device 104.

At 902: The memory device 104 processes the second write request.

For example, the memory device 104 performs a write procedure for the system metadata.

At 903: The memory controller 106 writes the first user data into the memory device 104 in response to completion of writing the system metadata into the memory device 104.

In some examples, the memory device 104 is configured to send a first write notification to the memory controller 106 in response to completion of processing of the second write request. The first write notification is to indicate to the memory controller 106 the completion of writing the system metadata. For example, after the memory device 104 completes the write procedure for the system metadata, the memory device 104 sends the first write notification to the memory controller 106, and after receiving the first write notification, the memory controller 106 determines that writing of the system metadata into the memory device 104 is completed, and writes the first user data into the memory device 104.

In some other examples, a status register is included in the memory device 104. In response to completion of processing of the second write request, a first level change (for example, changing from a high level to a low level or changing from a low level to a high level) occurs in the status register. When the first level change occurs in the status register, the memory controller 106 determines that the writing of the system metadata into the memory device 104 is completed, and the first user data will be written into the memory device 104. In some examples, the status register includes a flag bit, where the flag bit is to store level status data of the status register, and the memory controller 106 determines, by reading or listening to the level status data stored in the flag bit, whether a first level change occurs in the status register.

In some examples, the memory controller 106 is configured to write verification information corresponding to the first user data into the memory device 104 in response to completion of writing the system metadata into the memory device 104.

In some examples, the memory controller 106 is configured to write updating data of the system metadata buffered in a buffer 601 of the memory controller 106 into the memory device 104 in response to completion of writing the first user data into the memory device 104, and where the updating data indicates updating status of the system metadata in the process of writing the system metadata and the first user data into the memory device 104.

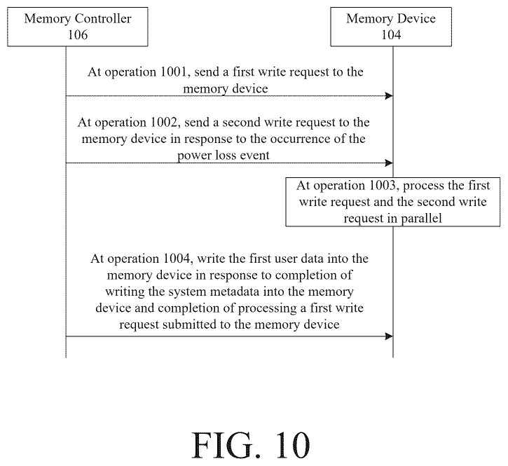

FIG. 10 is an interaction flowchart of a method of controlling a memory system provided by an example of present application. As shown in FIG. 10, the flow includes the following operation 1001 to operation 1004.

At 1001: the memory controller 106 sends a first write request to the memory device 104.

The first write request is a write request submitted to the memory device 104 before the occurrence of the power loss event, and the first write request indicates to write second user data buffered in the memory controller 106 into the memory device 104.

At 1002: the memory controller 106 sends a second write request to the memory device 104 in response to the occurrence of the power loss event.

The second write request indicates to write the system metadata into the memory device 104.

At 1003: the memory device 104 processes the first write request and the second write request in parallel.

For example, after the power loss event occurs, the memory controller 106 immediately sends a second write request to the memory device 104, and the memory device 104 performs a write procedure for the system metadata based on the second write request, and meanwhile, the memory device 104 continuously performs the write procedure for the second user data.

In some examples, a plurality of data transmission channels are included between the memory device 104 and the memory controller 106. For example, one memory controller 106 supporting 4 channels (data transmission channels) can simultaneously communicate with the memory device 104 through 4 independent data lines. In some examples, channel priority for the system metadata is higher than channel priority for the second user data, where the channel priority refers to occupation priority of the data transmission channel. For example, when the memory device 104 processes the second write request and the first write request in parallel, the number of data transmission channels that can be controlled for transmission of system metadata is greater than the number of data transmission channels for transmitting second user data.

In some examples, when the capacity of the backup capacitor is greater than or equal to a preset capacity, the second write request and the first write request are processed in parallel.

At 1004: the memory controller 106 writes the first user data into the memory device 104 in response to completion of writing the system metadata into the memory device 104 and completion of processing a first write request submitted to the memory device 104.

In some examples, the memory device 104 sends a first write notification to the memory controller 106 in response to completion of processing of the second write request. For example, after completing a write procedure for the system metadata, the memory device sends a first write notification to the memory controller 106, where the first write notification is to indicate to the memory controller 106 the completion of writing the system metadata. The memory device 104 sends a second write notification to the memory controller 106 in response to completion of processing of the first write request. In an example, when the memory device 104 completes the write procedure for the second user data, it sends the second write notification to the memory controller 106. The second write notification is to indicate to the memory controller 106 the completion of writing the second user data, for example, the processing of the first write request submitted to the memory device 104 is completed. After receiving the first write notification and the second write notification, the memory controller 106 determines that writing of the system metadata into the memory device 104 is completed and processing of the first write request submitted to the memory device 104 is completed, and writes the first user data into the memory device 104.

In some other examples, a status register is included in the memory device 104. In response to completion of processing of the second write request, a first level change (for example, changing from a high level to a low level or changing from a low level to a high level) occurs in the status register. In response to completion of processing of the first write request, a second level change (for example, changing from a high level to a low level or changing from a low level to a high level) occurs in the status register. When the second level change occurs after the first level change occurs in the status register, the memory controller 106 determines that writing of the system metadata into the memory device 104 is completed and the processing of the first write request submitted to the memory device 104 is completed, and writes the first user data into the memory device 104.

In some examples, the memory controller 106 writes an updated address mapping relationship into the memory device 104 in response to completion of writing the system metadata into the memory device 104 and completion of processing the first write request submitted to the memory device 104, where the updated address mapping relationship includes a mapping relationship between a logical address and a physical address of the second user data.

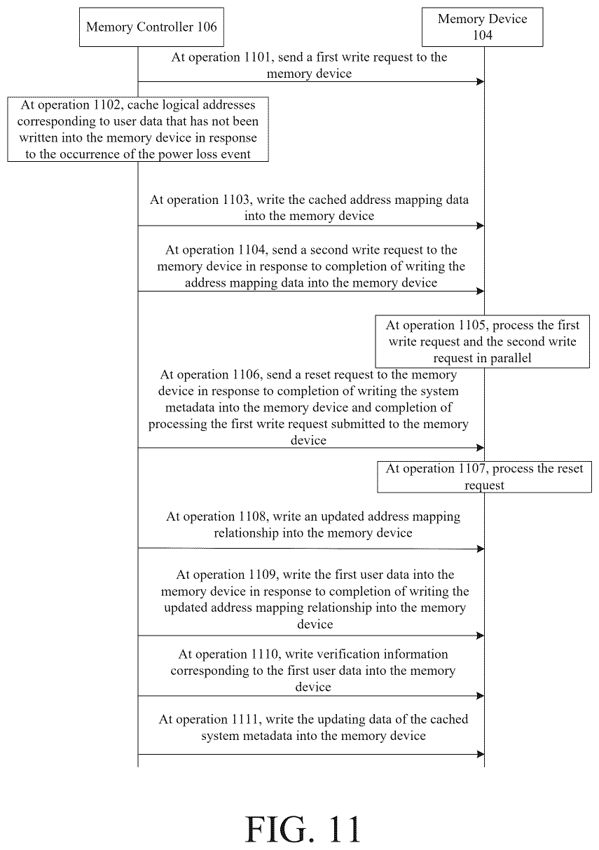

FIG. 11 is an interaction flowchart of a method of controlling a memory system provided by an example of present application. As shown in FIG. 11, the flow includes the following operation 1101 to operation 1111.

At 1101: the memory controller 106 sends a first write request to the memory device 104.

The first write request is a write request submitted to the memory device 104 before the occurrence of the power loss event, and the first write request indicates to write second user data buffered in the memory controller 106 into the memory device 104.

At 1102: the memory controller 106 buffers logical addresses corresponding to user data that has not been written into the memory device 104 in response to the occurrence of the power loss event.

The logical addresses include addresses used by a user or a file system to access user data, and are different from actual physical addresses within the memory device 104. In present application, when a power loss event occurs in the memory system 102, the memory controller 106 records logical addresses of user data that has not been written into the memory device 104, so that the user data can be correctly written into correct locations within the memory device 104 after power is restored.

In some examples, the user data that has not been written into the memory device 104 includes the first user data.

In some examples, the user data that has not been written into the memory device 104 further includes the second user data.

At 1103: the memory controller 106 writes the buffered address mapping data into the memory device 104.

The address mapping data includes an address mapping relationship between a physical address and a logical address.

A physical address refers to an actual storage location in the memory device 104. For example, an address mapping table is stored in the buffer 601 of the memory controller 106, where the address mapping table is to record an address mapping relationship between the physical address and the logical address. In the present application, when a power loss event occurs in the memory system 102, the memory controller 106 writes the address mapping table into the memory device 104.

At 1104: the memory controller 106 sends a second write request to the memory device 104 in response to completion of writing the address mapping data into the memory device.

The second write request indicates to write system metadata into the memory device 104.

In some examples, the memory device 104 sends a third write notification to the memory controller 106 in response to completion of writing the address mapping data. For example, after the memory device 104 completes the writing procedure for the address mapping data, it sends a third write notification to the memory controller 106, where the third write notification is to indicate to the memory controller 106 the completion of writing of the address mapping data. After receiving the third write notification, the memory controller 106 determines that the writing of the address mapping data into the memory device 104 is completed, and sends a second write request to the memory device 104.

In some other examples, a status register is included in the memory device 104. In response to completion of writing of the address mapping data, a third level change (for example, changing from a high level to a low level or changing from a low level to a high level) occurs in the status register. When the third level change occurs in the status register, the memory controller 106 determines that writing of the address mapping data into the memory device 104 is completed, and sends a second write request to the memory device 104.

At 1105: the memory device 104 processes the first write request and the second write request in parallel.

For example, after the power loss event occurs, the memory controller 106 immediately sends a second write request to the memory device 104, and the memory device 104 performs a writing procedure for the system metadata based on the second write request, and meanwhile, the memory device 104 continuously performs a writing procedure for the second user data.

At 1106: the memory controller 106 sends a reset request to the memory device 104 in response to completion of writing the system metadata into the memory device 104 and completion of processing a first write request submitted to the memory device 104.

The reset request indicates to terminate a data erase event performed in the memory device 104.

In some examples, the memory device 104 sends a first write notification to the memory controller 106 in response to completion of processing the second write request, where the first write notification indicates to the memory controller 106 the completion of writing the system metadata. The memory device 104 sends a second write notification to the memory controller 106 in response to completion of processing of the first write request, where the second write notification is to indicate to the memory controller 106 the completion of processing of the first write request. After receiving the first write notification and the second write notification, the memory controller 106 determines that writing of the system metadata into the memory device 104 is completed and processing of the first write request submitted to the memory device 104 is completed, and sends a reset request to the memory device 104.

In some other examples, a status register is included in the memory device 104. In response to completion of processing of the second write request, a first level change (for example, changing from a high level to a low level or changing from a low level to a high level) occurs in the status register. In response to completion of processing of the first write request, a second level change (for example, changing from a high level to a low level or changing from a low level to a high level) occurs in the status register. When the second level change occurs after the first level change occurs in the status register, the memory controller 106 determines that writing of the system metadata into the memory device 104 is completed and the processing of the first write request submitted to the memory device 104 is completed, and sends the reset request to the memory device 104.

At 1107: the memory device 104 processes the reset request.

After receiving the reset request, the memory device 104 terminates a data erase event. For example, the data erase event is one of basic operations of a flash memory (such as a NAND flash memory), and its core objective is to reset data in a memory block to an initial state (all 1) for new data writing.

At 1108: the memory controller 106 writes the updated address mapping relationship into the memory device 104.

The updated address mapping relationship includes a mapping relationship between a logical address and a physical address of the second user data. In some examples, the updated address mapping relationship further includes a mapping relationship between a logical address and a physical address of the system metadata.

In some examples, after the memory device 104 completes the processing of the reset request, a reset completion notification is sent to the memory controller 106. After receiving the reset completion notification, the memory controller 106 writes the updated address mapping relationship into the memory device 104.

In some other examples, a status register is included in the memory device 104. In response to completion of processing of the reset request, a fourth level change (for example, changing from a high level to a low level or changing from a low level to a high level) occurs in the status register. When the fourth level change occurs in the status register, the memory controller 106 determines that the processing of the reset request is completed, and writes the updated address mapping relationship into the memory device 104.

At 1109: the memory controller 106 writes the first user data into the memory device 104 in response to completion of writing the updated address mapping relationship into the memory device 104.

In some examples, after the memory device 104 completes the writing procedure for the updated address mapping relationship, a fourth write notification is sent to the memory controller 106, where the fourth write notification is to indicate to the memory controller 106 that writing of the updated address mapping relationship is completed. After receiving the fourth write notification, the memory controller 106 determines that writing of the updated address mapping relationship into the memory device 104 is completed, and writes the first user data into the memory device 104.

In some other examples, a status register is included in the memory device 104. In response to completion of the writing procedure for the updated address mapping relationship by the memory device 104, a fifth level change (for example, changing from a high level to a low level or changing from a low level to a high level) occurs in the status register. When the fifth level change occurs in the status register, the memory controller 106 determines that the writing procedure for the updated address mapping relationship into the memory device 104 is completed, and writes the first user data into the memory device 104.

At 1110: the memory controller 106 writes verification information corresponding to the first user data into the memory device 104.

In some examples, the verification information may include RAID check code, where the RAID check code is generated by exclusive OR (XOR) operations. For example, the first user data includes at least two data blocks, and the verification information refers to an XOR result between the at least two data blocks. For example, verification information=user data A XOR user data B, or verification information=user data A XOR user data B XOR user data C.

At 1111: the memory controller 106 writes the updating data of the buffered system metadata into the memory device 104.

The updating data indicates updating status of the system metadata in the process of writing the system metadata and the first user data into the memory device 104.

For example, after the memory controller 106 successfully writes the first user data into the memory device 104, the memory controller 106 writes the updating data of the system metadata buffered in the buffer 601 into the memory device 104. The updating data records the updating status of the system metadata during the entire process of writing the system metadata and the first user data into the memory device 104.

An example of present application provides an electronic device, where the electronic device includes the memory system 102 described in any one of the foregoing examples, and a host 108 coupled to the memory system 102. The electronic device may include a mobile phone, a desktop computer, a laptop computer, a tablet computer, a vehicle computer, a game console, a printer, a positioning device, a wearable electronic device, a smart sensor, a virtual reality device, an augmented reality device, or the like.

An example of the present disclosure provides a computer readable storage medium, having stored thereon at least one computer program that, when loaded and executed by a processor, perform the method of controlling the memory system according to any one of the above examples. In some examples, the computer readable storage medium includes a Non-Transitory Readable Storage Medium. For example, the at least one computer program is stored in the memory device 104 of the solid state disk SSD, runs in a tightly coupled memory (TCM) of the memory controller 106 of the solid state disk SSD or a buffer of the memory controller 106, and is executed by a processor of the memory controller 106 of the solid state disk SSD to implement the method of controlling the memory system according to any one of the foregoing examples.

The example of the present application provides a computer program stored in a computer readable storage medium. The processor reads the computer program from the computer readable storage medium, so that the processor loads and executes the computer program to implement the method of controlling the memory system provided in the foregoing method examples.

In present application, the terms “first” and “second” are used for descriptive purposes only, and cannot be understood as indicating or implying relative importance. The term “at least one” refers to one or more, and the term “a plurality of” refers to two or more, unless expressly defined otherwise.

The term “at least one of . . . or . . . ” in present application is merely an association relationship between related objects, indicating three possible scenarios. For example, “at least one of A or B” may indicate: A exists alone, A and B exist simultaneously, and B exists alone. Additionally, the character “/” in this document generally indicates that the associated objects before and after it are in an “or” relationship. The above descriptions are merely examples of this application and are not intended to limit its scope. Any modifications, equivalent replacements, or improvements made within the spirit and principles of this application shall be included within the protection scope of this application.

What is claimed is:

1. A memory system, comprising:
a memory device; and
a memory controller having first user data and system metadata buffered therein and configured to:
write the system metadata into the memory device in response to occurrence of a power loss event; and
write the first user data into the memory device in response to completion of writing the system metadata into the memory device.

2. The memory system according to claim 1, wherein the memory controller is configured to:
write the first user data into the memory device in response to completion of writing the system metadata into the memory device and completion of processing a first write request submitted to the memory device, and wherein
the first write request is a write request submitted to the memory device before the occurrence of the power loss event, and the first write request indicates to write second user data buffered in the memory controller into the memory device.

3. The memory system according to claim 2, wherein,
the memory controller is configured to:
send a second write request to the memory device in response to the occurrence of the power loss event, wherein the second write request indicates to write the system metadata into the memory device, and wherein
the memory device is configured to:
process the second write request and the first write request in parallel.

4. The memory system according to claim 2, wherein the memory controller is configured to:
write an updated address mapping relationship into the memory device in response to completion of processing the first write request submitted to the memory device, and wherein
the updated address mapping relationship comprises a mapping relationship between a logical address and a physical address of the second user data.

5. The memory system according to claim 1, wherein the memory controller is configured to:
buffer logical addresses corresponding to user data that has not been written into the memory device in response to the occurrence of the power loss event, wherein the user data that has not been written into the memory device comprises the first user data; and
write the system metadata into the memory device in response to completion of buffering the logical addresses.

6. The memory system according to claim 1, wherein the memory controller is configured to:
send a reset request to the memory device in response to the occurrence of the power loss event, wherein the reset request indicates to terminate a data erase event performed in the memory device.

7. The memory system according to claim 1, wherein the memory controller is configured to:
write address mapping data buffered in a buffer of the memory controller into the memory device in response to the occurrence of the power loss event, wherein the address mapping data comprises an address mapping relationship between a physical address and a logical address; and
write the system metadata into the memory device in response to completion of writing the address mapping data into the memory device.

8. The memory system according to claim 1, wherein the memory controller is configured to:
write verification information corresponding to the first user data into the memory device in response to completion of writing the system metadata into the memory device.

9. The memory system according to claim 1, wherein the memory controller is configured to:
write updating data of the system metadata buffered in a buffer of the memory controller into the memory device in response to completion of writing the first user data into the memory device, and wherein
the updating data indicates updating status of the system metadata in the process of writing the system metadata and the first user data into the memory device.

10. The memory system according to claim 1, wherein the memory system comprises a solid state drive.

11. The memory system according to claim 1, wherein the memory device comprises a single-level cell.

12. A method of controlling a memory system, comprising:
writing system metadata buffered in a memory controller into a memory device in response to occurrence of a power loss event; and
writing first user data buffered in the memory controller into the memory device in response to completion of writing the system metadata into the memory device.

13. The method according to claim 12, wherein writing the first user data buffered in the memory controller into the memory device in response to completion of writing the system metadata into the memory device comprises:
writing the first user data into the memory device in response to completion of writing the system metadata into the memory device and completion of processing a first write request submitted to the memory device, and wherein
the first write request is a write request submitted to the memory device before the occurrence of the power loss event, and the first write request indicates to write second user data buffered in the memory controller into the memory device.

14. The method according to claim 13, wherein writing the system metadata buffered in the memory controller into the memory device in response to the occurrence of the power loss event comprises:
sending a second write request to the memory device in response to the occurrence of the power loss event, wherein the second write request indicates to write the system metadata into the memory device, and wherein
the memory device is configured to process the first write request and the second write request in parallel.

15. The method according to claim 13, further comprising:
writing an updated address mapping relationship into the memory device in response to completion of writing the system metadata into the memory device and completion of processing the first write request submitted to the memory device, and wherein
the updated address mapping relationship comprises a mapping relationship between a logical address and a physical address of the second user data.

16. The method according to claim 12, wherein writing the system metadata buffered in the memory controller into the memory device in response to the occurrence of the power loss event comprises:
buffering logical addresses corresponding to user data that has not been written into the memory device in response to the occurrence of the power loss event, wherein the user data that has not been written into the memory device comprises the first user data; and
writing the system metadata into the memory device in response to completion of buffering the logical addresses.

17. The method according to claim 12, further comprising:
sending a reset request to the memory device in response to the occurrence of the power loss event, wherein the reset request is to terminate a data erase event performed in the memory device.

18. The method according to claim 12, wherein writing the system metadata buffered in the memory controller into the memory device in response to the occurrence of the power loss event comprises:
writing address mapping data buffered in the memory controller into the memory device in response to the occurrence of the power loss event, wherein the address mapping data comprises an address mapping relationship between a physical address and a logical address; and
writing the system metadata into the memory device in response to completion of writing the address mapping data into the memory device.

19. The method according to claim 12, further comprising:
writing verification information corresponding to the first user data into the memory device in response to completion of writing the system metadata into the memory device.

20. A memory controller, comprising:
a buffer configured to buffer first user data and system metadata;
one or more processors configured to:
write the system metadata into a memory device in response to occurrence of a power loss event; and
write the first user data into the memory device in response to completion of writing the system metadata into the memory device.
